(19) United States
(12) Patent Application Publication
(10) Pub. No.: US 2005/0098495 A1
(43) Pub. Date: May 12, 2005

(54) Purification materials and method of filtering using the same

(76) Inventor: Kenneth D. Hughes, Alpharetta, GA (US)

Correspondence Address: JOHN S. PRATT, ESQ;KILPATRICK STOCKTON, LLP, 1100 PEACHTREE STREET, ATLANTA, GA, 30309, US

(21) Appl. No.: 10/469,653

(22) PCT Filed: Feb. 18, 2002
(86) PCT No.: PCT/US02/04786

Related U.S. Application Data
(60) Provisional application No. 60/272,950, filed on Mar. 2, 2001.

(51) Int. Cl. B01D 39/14

(52) U.S. Cl. 210/502.1; 210/507; 210/508; 210/509

(57) ABSTRACT

The invention relates to a purification material (1) comprising filtration particulate matter aggregated with a first binder and further processed with a second binder to generate a porous fluid filtration material or a non-pourous coating, a filtering device comprising a housing (11) and the purification material (1), and a method of filtering and/or purifying a fluid including water or other solutions containing chemical and microbiological contaminants, such as fluids containing heavy metals, pesticides, by products of oxidation chemicals and including cysts, bacteria and/or viruses, where the fluid is passed through ot made to contact a surface of the purification material (1).

### FIELD OF THE INVENTION

This invention relates generally to the field of solution and fluid filters or purification devices, primarily to aqueous solution filters and water purification, devices for gases and water and other aqueous liquids, which remove contaminants from the gas or aqueous liquid solution passed through them. In its more particular aspects, the invention relates to the field of such devices that remove chemical and microbiological contaminants, including pesticides, byproducts of chemical treatment processes, cysts, bacteria and viruses and their components, from water or aqueous solutions.

### BACKGROUND OF THE INVENTION

Purification or filtration of water or other aqueous solutions is necessary for many applications, from the provision of safe or potable drinking water to biotechnology applications including fermentation processing and separation of components from biological fluids. Similarly, the removal of microbial organisms from breathable air in hospitals and clean rooms, where ultrapurified air is required, and in environments where the air will be recirculated, such as aircraft or spacecraft, is also an important application for filtration media. In recent years, the need for air filtration and purification in the home has become more recognized, and the competing concerns of energy efficiency and indoor air quality have lead to numerous air filtration products, such as HEPA filters and the like, that purport to remove small particles, allergens, and even microorganisms from the air.

There are many well-known methods currently used for water purification, such as distillation, ion-exchange, chemical adsorption, filtering or retention, which is the physical occlusion of particulates. Particle filtration may be completed through the use of membranes or layers of granular materials, however in each case the pore size of the material and the space between the granular materials controls the particle size retained. Additional purification media include materials that undergo chemical reactions, which alter the state or identity of chemical species in the fluid to be purified.

In most cases a combination of techniques are required in order to completely purify fluids, such as water. Combinations of technologies may be implemented by combining functions in a single device or using several devices in series where each performs a distinct function. Examples of this practice include the use of mixed resins that remove both negative and positively charged chemical species as well as species without charge.

Many of these fluid purification techniques and practices are costly, energy inefficient and/or require significant technical know-how and sophistication. Traditional means of reducing these complications require extensive processing or specially designed apparatus. Unfortunately, development of low cost techniques do not adequately address the removal of harmful chemical and biological contaminates, such as, bacteria and viruses. For example, simple point-of-use purification devices, such as filters attached to in-house water supply conduits or portable units for campers and hikers, cannot sufficiently remove bacteria and viruses unless relatively costly membrane technology or strong chemical oxidizers, such as halogens or reactive oxygen species, are utilized.

The Environmental Protection Agency (EPA) has set forth minimum standards for acceptance of a device proposed for use as a microbiological water purifier. Common coliforms, represented by the bacteria E. coli and Klebsiella terrigena, must show a minimum 6-log reduction, 99.9999% of organisms removed, from an influent concentration of 1×10⁷/100 ml. Common viruses, represented by poliovirus 1 (LSc) and rotavirus (Wa or SA-11), which show resistance to many treatment processes, must show a minimum 4 log reduction, 99.99% of organisms removed, from an influent concentration of 1×10⁷/L. Cysts, such as those represented by Giardia muris or Giardia lamblia, are widespread, disease-inducing, and resistant to chemical disinfection. Devices that claim cyst removal must show a minimum 3 log reduction, 99.9% of cysts removed, from an influent concentration of 1×10⁶/L or 1×10⁷/L, respectively. The EPA has accepted the use of other particles in the appropriate size range as a means of testing devices that claim this function.

Materials that are highly efficient at removing and immobilizing microbial organisms have numerous applications, but a particular area of application is in the biotechnology and fermentation industries. Not only would such materials be useful in the processing of fermentation broth for recycling or reuse, they also would have utility as microbial immobilization materials for the microbes of interest to the fermentation process.

It is well known to use granular, particulate, or fibers of natural or synthetic materials for fluid treatment. These materials are commonly used singularly and in mixtures. In some cases a material which immobilizes the individual particles or fibers together, referred to as a binder, is used. Techniques for generating porous blocks of carbon using a polymer binder is described in prior art by companies such as KX Industries, Amway Corporation, and Cuno.

Natural materials used in filter applications include carbonaceous materials such as activated carbon and minerals such as apatites, oxides, hydroxides, phosphates, and silicates and combinations thereof.

Synthetic materials used in filter applications include hydrocarbon polymers, and mineral species such as apatites, oxides, hydroxides, phosphates, and silicates and combinations thereof.

The particle size of the filtration material used in filtration devices controls many of the technical specifications and successful application of a filtration device. Particle sizes commonly used include those in a range between 80 and 325 mesh. Grinding and milling of both natural and synthetic materials can be required to generate particles in this size range. Although particle sizes outside this range can be used they present practical problems. As example, small particles such as those smaller than 325 mesh are difficult to retain in the filtration device while particles larger than 80 mesh lack the needed surface area for many applications.

The grinding and milling of natural and synthetic materials often produces particles of varying size and distribution. Particles size distributions and mixtures of distributions are modified by sieving, particle collection, and recombination. Particle sizes that are too small for use in filtration devices often go to waste or must be left for other applications.

It is also common for synthetic materials to be synthesized in particle sizes that are too small for use in many filtration devices.

The use of soluble treatment chemicals for increasing particulate matter size in water and waste water treatment is well known. It is commonly understood that inorganic and organic materials can be used to flocculate, coagulate, and aggregate small particulate material found in a water stream. The resulting larger particles are now able to be filtered or to be removed from the water system through standard sedimentation and clarification methods. It is also well understood that many particulates in the water stream carry positive or negative charges and that this characteristic may be used to aggregate the small particles into larger species.

Accordingly, there remains a need in the art of fluid filtration for an uncomplicated, safe, inexpensive fluid purification and filtration method and device incorporating insoluble small filtration particles (<325 mesh) and soluble water treatment chemicals. It is the intention of this invention and art to generate filtration particulate material and filtration devices through the use of multiple different chemical binders. Furthermore it is the intention of this invention and method to permit the simultaneous use of activated carbon, silicates, oxides, metal hydroxides, and phosphates in the forms which are readily available and commonly found or synthesized by a variety of different methods. There is also a need in the art for a method and device that can address the EPA requirements for designation as chemical and microbiological water purifiers, such that the device is more than suitable for consumer and industry point-of-use and point-of-entry applications.

### SUMMARY OF THE INVENTION

To this end, the present inventors have discovered that a significant problem in the known use of small particulate inorganic and organic materials, called fines, incorporated into filter devices is that the particles are difficult to contain thus requiring very small pore size containers which increases the back pressure of devices. Small particles also tend to plug devices which leads to short product lifetimes. Loss of particulate material decreases or inhibits product performance, can cause illness, and presents a general annoyance for devices users. Finally, as with all particulate containing devices, grinding of particles as a result of particle movement generates even smaller particles.

Additionally, the present inventors have discovered that there also exists a significant problem in the known binding methods used to generate filter devices. As the size of the filtration particles decreases an increase in the amount of polymer binder is required in order to retain and immobilize the particles. The increase in binder levels required often generates filtration blocks with small pores which increases device backpressure.

The invention disclosed provides a means for using small filtration particulate matter (<325 mesh), material fines, generated from the processing of natural or synthetic materials or from the synthesis of materials for the generation of porous blocks suitable for fluid filtration.

The invention in general involves the use of multiple organic and/or inorganic binders to first increase the particulate matter size, and subsequently to generate porous blocks or sheets or coatings. Non-flow through coated surfaces which function by contact filtration are also considered an important material that may be used in the invention.

The method of the invention involves two steps. The first step involves taking small particles or fines in the size range between 10 nanometers and 200 microns and aggregating or agglomerating them into larger particles through the use of positively charged, negatively charged, and/or uncharged organic or inorganic polymers, and/or compounds such as oxides, hydroxides, phosphates, and silicates. Examples of suitable binders include, polyelectrolytes such as polyamines, polyalcohols, polysaacharides, polyacrylates, polyacrylamides and derivitized natural and synthetic polymers, oxides of magnesium and calcium, and hydroxides of calcium, magnesium, aluminum, and iron. Additionally, precipitation of hydroxide and phosphate compounds may be used.

This first processing step may also include mechanical steps, such as mixing, spraying, dripping or fluidic processing. This step may also include heat treatment, including digestion, calcining, sintering, and firing. The chemical and physical processing of this step may be repeated until the particles are of appropriate size, which is usually greater than 325 mesh. It should be understood that during the first step of the invention, the binder may be partially or fully removed by the various processing methods.

The second step in the invention involves taking the particulate material generated in step 1, particles of significantly greater size, and combining them with a second binder, of different type, which immobilizes the particles into a porous block. This second step may utilize standard techniques such as extrusion, molding, and pressure.

The invention and method provides an efficient means of using small particles which are difficult to implement in the generation of filtration devices.

There are numerous advantageous to the method of this invention. First, the initial starting particles have very large surface areas which increases the filtration efficiency of the filtration device when they are included as components of larger particles which are now retained in the device.

Second, the invention provides the ability to simultaneously use a mixture or agglomeration of different filtration particle types. As an example, carbon, apatite, silicate, metal oxide, hydroxide, and/or sulfur containing particles may be agglomerated to generate a mixed composition particle.

Third, the method provides a means of producing insoluble water treatment polymer materials from previously soluble polymeric compounds and retaining them in the filtration device. As an example, high molecular weight charged water treatment polymers have a plethora of active binding sites. By using some of the active binding sites to bind particulate material the polymer is rendered insoluble. Since only some of the many active binding sites are used for particle binding there still remains many active binding sites which are now available for participating in the fluid stream filtration, for the removal of chemical and biological contaminants.

Fourth, the method allows the use of materials that are hazardous in larger sizes such as magnesium containing silicates in asbestos form to be used in safer smaller particulate sizes.

Fifth, the method provides a means for utilizing nanometer size particles of metals and metal oxides that are of interest in fluid catalysis and chemical stream processing.

It should be understood that the present invention may also be used for generating particles in a size range greater than 100 mesh. Unfortunately, the effectiveness of filters generated with larger materials with or without a binder is compromised by channeling and by-pass effects caused by the pressure of fluid, in particular, water and aqueous solutions, flowing through the filter media as well as particle erosion and aggregation. Because many chemicals, viruses and bacteria are removed by intimate contact with the adsorption material, even relatively small channels or pathways in the granular material formed over time by water pressure, water flow, particle erosion, or particle aggregation are easily sufficient to allow passage of the undesirable chemical and microbiological contaminants through the filter.

For example, taking water as an exemplary fluid and using the material of the invention as a filtration medium for microbial organisms, calculations based on a virus influent concentration of 1×10⁶/L show that where a 4-log reduction is to be expected, only a 3.7 log reduction actually occurs if only 0.01% of the water bypasses treatment by passing through channels formed in the filter media during filtration. If 0.1% of the water passes through untreated, then only a 3 log reduction occurs. If 1% passes through untreated, only a 2 log reduction occurs, and if 10% passes untreated, only a 1 log reduction occurs. Where a 6-log reduction is expected, the detrimental results of channeling are even more dramatic, with only a 4-log reduction actually occurring when 0.01% of the water bypasses treatment. This invention solves this problem by providing a method and device for removing contaminants, including chemicals, bacteria and viruses, where very small particulate filtration materials and device adsorptive filter media are immobilized with multiple chemical binders material to form a porous filter material that eliminates the possibility of channeling and active material by-pass.

This invention is, in general, a device and method for the purification and filtration of aqueous fluids, in particular water (such as drinking water or swimming or bathing water), or other aqueous solutions (such as fermentation broths and solutions used in cell culture), or gases and mixtures of gases, such as breathable air, found in clean rooms, hospitals, diving equipment homes, aircraft, or spacecraft, and gases used to sparge, purge, or remove particulate matter from surfaces. The use of the device and method of the invention results in the removal of an extremely high percentage of microbiological contaminants, including bacteria and viruses and components thereof as well as chemical contaminants such as heavy metals, pesticides and by products of chemical treatment processes. In particular, the use of the device and method of the invention results in purification of water to a level that addresses the EPA standards for chemical or microbiological water purification.

In one embodiment, the invention relates to a purification material for fluids that contains particulate carbon that is in the form of a porous block as the result of employing multiple binders. Typically, at least a portion of this carbon is activated and from natural sources.

In another embodiment, the invention relates to a purification material for fluids that contains particulate apatite minerals that is in the form of a porous block as the result of the presence of the multiple binders. Apatites are commonly mined, prepared from natural sources (bone char), or synthesized from calcium and phosphorus containing compounds.

In another embodiment, the invention relates to a purification material for fluids that contains particulate oxide and hydroxide minerals that are in the form of a porous block as the result of the presence of the multiple binders. Aluminum, iron, and magnesium oxides are commonly mined and purified from natural sources (alumina/bauxite, chlorides), or synthesized from aluminum, magnesium containing minerals, or generated from synthetic sources such as the mixing of aluminum, iron, and magnesium containing compounds.

In another embodiment, the invention relates to a purification material for fluids that contains particulate silicate minerals that are in the form of a porous block as the result of the presence of the multiple binders. Aluminum, calcium, iron, magnesium, sodium, and potassium containing silicates are commonly mined and purified from natural sources, or synthesized from aluminum, calcium, iron, magnesium, sodium, or potassium containing compounds.

In another embodiment, the invention relates to a purification material for fluids that contains particulate metals important in catalysis that are in the form of a porous block as the result of the presence of the multiple binders. Platinum group metals, such as platinum, rhodium, and palladium, as well as coinage metals, such as gold, silver, copper, and nickel, as well as heavy metals, such as cadmium and chromium, are commonly mined and purified from natural sources, or reclaimed from spent electronic components.

In another embodiment, the invention relates to a purification material for fluids that contains a mixture of the particulate filtration materials described in the individual embodiments of this invention that are in the form of a porous block as the result of the presence of the multiple binders. The mixtures included in this embodiment can vary dramatically with individual components included varying from less than 1% through greater than 99%.

In yet another embodiment, the invention relates to a purification material for fluids that contains a mixture of particulate filtration materials generated by combining particulate material generated by a method consistent with the first step of this invention with materials that have been generated through traditional methods, such as grinding and or milling. The mixture of particles is then processed into the form of a porous block as the result of the presence of the binders and method consistent with the second step of the method. The mixtures of particles generated in the different processes included in this embodiment can vary dramatically with individual components included varying from less than 1% through greater than 99%.

Also typically, the binders used are inorganic or organic compounds including polymeric or oligomeric materials that are capable of maintaining the particulate material in a particulate form (first binder) and in block structure form (second binder). This allows the purification material to be extruded, molded or pressed into any desired shape, e.g., a shape suitable for inclusion into the housing of a filtration device, which provides for fluid inflow and outflow, and which filtration device has one or more chambers for contact of the fluid with the purification material. Such a device forms another embodiment of the invention. In addition to maintaining the filtration particles immobilized in a unitary block, the polymeric binders also provide desirable physical characteristics to the filter material, e.g., rendering it rigid or flexible, depending upon the type and amount of polymeric binders used.

In another embodiment, the invention relates to a purification material for fluids that is in the form of a self-supporting sheet or membrane containing the particulate filtration immobilized with the binders.

In another embodiment, the invention relates to a purification material for fluids that is in the form of a porous coating supported by a porous substrate containing the particulate filtration immobilized with the binders.

In another embodiment, the invention relates to a purification material for fluids that is in the form of a nonporous coating supported by a porous or nonporous substrate containing the particulate filtration immobilized with the binders. Here the fluid is filtered by surface contact.

The invention also relates to methods of filtering fluids, such as water, aqueous solutions, and gases, to remove a large proportion of one or more types of chemicals, microorganisms contained therein, by contacting the fluid with the purification material of the invention. In a particular aspect of this embodiment of the invention, this contacting occurs within the device described above, with the unfiltered fluid flowing through an inlet, contacting the purification material in one or more chambers, and the filtered fluid flowing out of the chamber through an outlet.

The purification material of the invention can be used to purify drinking water, to purify water used for potable and/or recreational purposes, such as in swimming pools, hot tubs, and spas, to purify process water, e.g. water used in cooling towers, to purify aqueous solutions, including, but not limited to, blood, fermentation broths, and cell culture solutions (e.g., for solution recycling in fermentation or other cell culture processes) and aqueous fluids used in surgical procedures for recycle or reuse, and to purify gases and mixtures of gases such as breathable air, for example, air used to ventilate hospital or industrial clean rooms, air used in diving equipment, or air that is recycled, e.g., in airplanes or spacecraft, and gases used to sparge, purge or remove volatile or particulate matter from surfaces, containers, or vessels. The purification material of the invention has the additional advantage of making use of readily available filtration materials and more especially small particulate materials, including those obtained from natural and synthetic sources, while still maintaining high purification efficiency.

In yet another embodiment of the invention, the materials of the invention, namely small filtration particulate matter and optionally other adsorptive materials with a multiple binder matrix and which is formed into a block or sheet or coating, can be used as an immobilization medium for microorganisms used in biotechnology applications such as fermentation processes and cell culture. In this embodiment, biological process fluids, such as nutrient broths, substrate solutions, and the like, are passed through or over the immobilization material of the invention in a manner that allows the fluids to come into contact with the microorganisms immobilized therein and thereon, and effluent removed from the material and further processed as needed.

### BRIEF DESCRIPTION OF THE DRAWINGS

FIG. 1 is a cross-sectional view illustrating a particular embodiment of the invention, namely a water filter housing containing a block filter incorporating synthetic apatite minerals and granulated activated charcoal (GAC) in a multiple binder matrix according to the invention.

FIGS. 2a and 2b are schematic views of a particular embodiment of the invention, namely a filter material containing synthetic apatite minerals and granulated activated charcoal (GAC) and a multiple binder matrix in the form of a membrane or sheet.

### DETAILED DESCRIPTION OF THE INVENTION

As indicated above, one embodiment of the invention relates to a purification material in the form of a block filter containing granulated carbon, such as activated carbon, and synthetic or natural apatite (hydroxy-calcium-phosphate) with a first binder to increase filtration particle size and a second binder which generates a porous block. The first binder is typically an organic polymer material, such as a polyamine, polyacrylamide, polyvinylalcohol, polyacrylic, or polyelectrolyte derived from natural or synthetic polymers or an inorganic material such as a metal oxide or hydroxide or a polysilane. The second binder employed for the purpose of generating the porous block is typically a thermoplastic such as polyethylene or material that generates immobilization pressure through fluid absorption.

In a particular aspect of this embodiment, the invention relates to a rigid porous block filter that contains a mixture of granulated carbon and apatite derivatives, or granulated activated charcoal (GAC) or bone char or other adsorptive filter media using a first binder material which is an inorganic, and a second binder, such as a thermoplastic material, such that the mineral materials and derivatives and GAC are fixed within the binder matricies, and that channeling from flow during water treatment cannot occur.

The final purification material of the invention can be produced by extrusion, molding including injection molding, or by fluid absorption/compression methods. Fibrillation may also be used to prepare fibrils of the mixture of first binder and mineral and carbon particulates that can then be formed into a sheet, film, or block. It may be produced in any shape or size and may be rigid or flexible.

The pore size of the filter block influences flow rates of the fluid through the filter, and is a function of the size of the granular particles generated in the first step and incorporated into the filter block in the second step. As used herein, the term “block” does not denote any particular geometrical shape, but rather that the material is not a sheet or membrane, or coating. Nonlimiting examples of “blocks” as this term is intended to be used include tubes, annular rings, as well as more conventional geometrical solids. Material formed into flexible blocks is particularly suitable for use in pipes or tubes that serve as the fluid filter medium.

One of the desirable features of the purification material of the invention is that it may be formed into any desired shape, and thus provides ease of handling and use. For example, the purification material may be formed into a monolith or block that fits into conventional housings for filtration media or it can be shaped to provide purification as part of a portable or personal filtration system. Alternatively, the material may be formed into several different pieces, through which water flows in series or in parallel. Sheets or membranes of the purification material may also be formed. The rigidity of the purification material, whether in block form or in sheet/membrane/coating form, may be altered through inclusion of flexible polymers in the binder material.

While not wishing to be bound by any theory, it is believed that the purification material of the invention achieves its unusually high efficiency in removing chemicals and microorganisms from fluids partly as the result of the immobilization of the filtration particles in the binders, and the necessity for fluid flowing through the purification material to follow an extended and tortuous path therethrough, instead of forming channels through the purification material as occurs in prior particulate-containing purification materials. This path ensures that the fluid contacts a larger proportion of the surface area of the filtration particles, and it prevents sustained laminar flow of the fluid through the filtration material. This latter effect is believed to help prevent laminae of fluid containing chemicals and microorganisms from avoiding sustained contact with the filtration particles in the filter. After the purification material has been in service for a period of time, additional filtration by occlusion will occur as adsorbed material accumulates in the pores of the purification material.

Those familiar with the art of fluid filtration will understand that the pore size and physical dimensions of the purification material may be manipulated for different applications and that variations in these variables will alter flow rates, back-pressure, and the level of chemical and microbiological contaminant removal. Likewise those knowledgeable in the art will recognize that variations in the percentages of each component of the purification material will provide some variability in utility. For example, increasing the percentage of filtration particulate material in the purification material will result in a material having an increased number of interaction sites for chemical and biological species, while increasing the percentage of a binder with no active fluid treatment sites will result in a purification material having material and mechanical properties closer to that of the binder material and with reduced interaction sites.

In one particular embodiment of the invention, the mineral material used is in the form of apatite, and the hydroxyapatite and GAC material are present in approximately equal amounts, with the percentage of both the first and second binder materials kept to a minimum. However, the mineral adsorbents used in the invention may be obtained from other natural or synthetic/industrial sources and mixtures of the different derivatives can provide differences in the properties of the purification material. For example, adding fluoride to the filter block will result in a decreased reduction of fluoride in the effluent water if water is used as the fluid. This can be useful in, e.g. purifying fluorinated water in such a way as to maintain desirable fluorine levels therein. Fluoride in the filter material may be obtained either by inclusion of fluoride containing apatite, inclusion of fluoride salts and compounds, or by pre-conditioning the purification material by passing fluoride-containing solutions therethrough.

Likewise, as the number of binding sites is increased through the use of different crystal and material structures and orientation of different crystal faces, the binding of metal ions, radioactive isotopes, and microorganisms can also be increased. Commonly, exposure to increased temperatures allows conversion between crystalline and amorphous forms. Furthermore choosing a first, and or second binder material with active fluid treatment sites such as those which occur with charged and uncharged binders facilitates the “tailoring” of the filtration material for specific applications.

Those experienced in the art will also understand that different crystal or amorphous lattices are possible for mineral filtration particles, and for other adsorbent materials used in the invention, and that these variations will yield differences in properties of the resulting purification material, as certain crystal structures improve and inhibit interactions with chemicals, microorganisms and other biological materials. These differences in properties result from differences in interactions between the chemicals and microorganisms and other biological materials and the different positive, negative ions, and neutral species that are included in the crystal structure.

In another embodiment of the invention, the purification material is constructed to withstand sterilization. Sterilization processes include thermal processes, such as steam sterilization or other processes wherein the purification material is exposed to elevated temperatures or pressures or both, resistive heating, radiation sterilization wherein the purification material is exposed to elevated radiation levels, including processes using ultraviolet, infrared, microwave, and ionizing radiation, and chemical sterilization, wherein the purification material is exposed to elevated levels of oxidants or reductants or other chemical species, and which is performed with chemicals, such as halogens, reactive oxygen species, formaldehyde, surfactants, metals and gases such as ethylene oxide, methyl bromide, beta-propiolactone, and propylene oxide.

Additionally, sterilization may be accomplished with electrochemical methods by direct oxidation or reduction with microbiological components or indirectly through the electrochemical generation of oxidative or reductive chemical species. Combinations of these processes may also used. It should also be understood that sterilization processes may be used on a continuous or batch basis while the purification material is in use.

In general, the invention comprises a device and a method for the filtration and purification of a fluid, in particular an aqueous solution or water, to remove organic and inorganic elements and compounds present in the water as particulate material. In particular, the device and method can be used to remove microbiological contaminants, including cysts, bacteria and viruses and components thereof, as well as chemical species, such as pesticides and byproducts of chemical treatment processes, from water or other fluids or gasses destined for consumption or other use by humans or other animals. The method and device of the invention are particularly useful in these applications where the reduction in concentration of chemical and microbiological contaminants made possible by the invention addresses the EPA standards for microbiological and chemical water purification devices, and also significantly exceeds the effectiveness of other known filtration and purification devices incorporating granulated adsorption media that contain filtration particulate matter in the absence of binder materials.

In a particular embodiment of the invention, the purification material is a porous block formed by granulated or particulate apatite, oxide, or silicate material, which is defined herein to include hydroxyapatite, alumina, and iron and/or magnesium containing silicates and other optional adsorptive granular materials, described in more detail below, such as granulated activated charcoal (GAC), retained within a multiple polymer binder matrix. In the method corresponding to this particular embodiment, the microbiological contaminants are removed from the water when the water is forced through the porous block by water pressure on the influent side, or by a vacuum on the effluent side, of the filter block.

In an embodiment of the invention where the purification material is composed of a mixture of apatite and/or an adsorptive granular filter media, for example GAC, such components can be dispersed in a random manner throughout the block. The purification material can also be formed with spatially distinct gradients or separated layers. For example, apatite and alumina and GAC granules may be immobilized in separate layers using a solid second binder matrix, for instance, a polymer thermoplastic such as polyethylene or the like, so that movement of the mineral particulate and GAC particles is precluded and detrimental channeling effects during fluid transport through the block are prevented. If the components reside in separate locations, the fluid flow is sequential through these locations. In a particular example of this embodiment, at least a portion of the apatite present originates from synthetic mixtures thereof. An example of a suitable material is that designated as tricalcium phosphate as sold by Murlin Chemical in PA and/or Brimac Carbon Services, UK, and carbon as provided by KX Industries in CT. The carbon material may be ground to a desirable particle size, e.g., 80×325 mesh. A typical analysis of these materials shows greater than 90% purity. The element binding characteristics of these materials have been reported and such elements include chlorine, fluorine, aluminum, cadmium, lead, mercury (organic and inorganic), copper, zinc, iron, nickel, strontium, arsenic, chromium, manganese, and certain radionuclides. The organic molecule binding capabilities have been reported for complex organic molecules, color-forming compounds, compounds that add taste to fluids, compounds that add odors to fluids, and trihalomethane precursors.

In this embodiment, the mineral species (apatite, oxide, hydroxide, silicate, etc.) and the GAC are mixed in approximately equal amounts with the minimal amount of first binder material required to generate particles in the 80×325 mesh size and the minimum amount of second binder necessary to generate a monolithic purification material. However, the amounts of mineral particulate matter, GAC, and binder are substantially variable, and materials having different concentrations of these materials may be utilized in a similar fashion without the need for any undue experimentation by those of skill in the art. In general, however, when GAC, or bone char is used as the additional adsorbent material, its concentration in the mixture is generally less than 50% by weight, based upon the weight of the composition before any drying or compacting. Additionally, adsorbents other than GAC may be substituted completely for, or mixed with, the GAC in a multicomponent mixture. Examples of these adsorbents include various ion-binding materials, such as synthetic ion exchange resins, zeolites (synthetic or naturally occurring), diatomaceous earth, metal hydroxides and oxides, in particular those containing the metals such as aluminum, calcium, magnesium, and iron and one or more other phosphate-containing materials, such as minerals of the phosphate class, in particular, minerals of the aluminosilicate group. In particular, minerals of the aluminosilicate group that contain magnesium, calcium, iron, sodium and or potassium, and mixtures thereof, are particularly suitable for the invention. These materials may be calcined, sintered, and/or purified by any of the well known mineral processing methods.

Additionally, polymeric materials for ion-binding, including derivatised resins of styrene and divinylbenzene, and methacrylate, may be used. The derivatives include functionalized polymers having anion binding sites based on quaternary amines, primary and secondary amines, aminopropyl, diethylaminoethyl, and diethylaminopropyl substituents. Derivatives including cation binding sites include polymers functionalized with sulfonic acid, benzenesulfonic acid, propylsulfonic acid, phosphonic acid, and/or carboxylic acid moieties. Natural or synthetic zeolites may also be used or included as ion-binding materials, including, e.g., naturally occurring aluminosilicates such as clinoptilolite.

Suitable materials for the first binder which is used to flocculate, coagulate and/or aggregate, small particulate matter into large particulate matter may include any material capable of aggregating the particulate materials together and maintaining this aggregation under the conditions of use. They are generally included in amounts ranging from about 1 wt % to about 99.9 wt %, more particularly from about 15 wt % to about 50 wt %, based upon the total weight of the purification material. If a polymeric binder material is used it may be charged positively, negatively, or uncharged and may originate from synthetic sources or natural sources. Suitable binders include polyamides, polyalcohols, polysaacharides, polyacrylamides, polyacrylates, humic acids, and proteins. Binders may also include materials such as metal hydroxides and oxides including those containing aluminum, calcium, magnesium, and iron and including polyaluminum sulfates and polyaluminum chlorides. Binders appropriate for this first step can include polorganozirconates, polyorganoaluminates, polysiloxanes, polysilanes, polysilazanes, polycarbosilanes, polyborosilanes, zirconium dimethacrulate, zirconium tetramethacrylate, zirconium 2-ethylhexanoate, aluminum butoxides, aluminum diisopropoxide ethylacetoacetate, tetramethyldisiloxanes and derivatives thereof, tristrimethylsilylphosphate, and tristrimethylsiloxyboron.

Exempliary first step binders also include polyelectrolytes carrying positive or negative charged chemical functionalities, or a combination thereof. These may include but are not limited to polyamines such as poly(DADMAC), Poly-DADM, Polyamine-Poly(DADMAC) blends, polyquartenary amines, inorganic-polyamine blends, and inorganic Poly(DADMAC) blends. Additionally, cationic starch, and cationic polymethylmethacrylates may be used. Also, copolymers of vinylimidazolium methochloride and vinylpyrrolidone, quarternized vinylpyrrolidone/dimethyl-aminoethyl-methacrylate copolymer, and polyethyleneimine. Companies manufacturing suitable materials include Vinings Industries, Cytec, BASF Corporation, Ontario Specialty Coatings Corp., International Specialty Products, and EKA Chemicals.

The primary requirement for the first binder is that it yields the appropriate particle size under the conditions which the second binder is employed for porous solid generation. Those skilled in the art will understand that the first binder may be employed through a number of physical processing methods including, but not limited to, dripping, spraying, solid state reaction, and solution state reaction. It should be understood by those experienced in the art that step processing methods may remove portions of the first binder while maintaining appropriate particle size and that processing with the second binder may remove or displace some of the first binder.

It should also be understood by those experienced in the art of water treatment that the interactions between insoluble treatment particles and the first binder may be classified as that of flocculation, coagulation, aggregation and combinations thereof. Additionally, it should be understood that different binders will react to varying degrees with water treatment oxidizers such as chlorine. It should also be understood that regulatory agencies such as the US FDA, US EPA, CEN, DWI, and KIWA have regulatory requirements for the concentration of these materials that may be present in food stuffs and potable waters.

Suitable materials for the second and other binders which are used to generate the monolithic porous block include any polymeric material capable of aggregating the particulate materials together and maintaining this aggregation under the conditions of use. They are generally included in amounts ranging from about 1 wt % to about 99.9 w %, more particularly from about 15 wt % to about 50 wt %, based upon the total weight of the purification material.

Suitable polymeric materials include both naturally occurring and synthetic polymers, as well as synthetic modifications of naturally occurring polymers. The polymeric binder materials generally include one or more thermoset, thermoplastic, elastomer, or a combination thereof, depending upon the desired mechanical properties of the resulting purification material.

In general, polymers melting between about 50° C. and about 500° C., more particularly, between about 75° C. and about 350° C., even more particularly between about 80° C. and about 200° C., are suitable polymeric binders for the invention. For instance, polyolefins melting in the range from about 85° C. to about 180° C., polyamides melting in the range from about 200° C. to about 300° C., and fluorinated polymers melting in the range from about 300° C. to about 400° C., can be particularly mentioned as suitable. Examples of types of polymers suitable for use as binders in the invention include, but are not limited to, thermoplastics, polyethylene glycols or derivatives thereof, polyvinyl alcohols, polyvinylacetates, and polylactic acids. Suitable thermoplastics include, but are not limited to, nylons and other polyamides, polyethylenes, including LDPE, LLDPE, HDPE, and polyethylene copolymers with other polyolefins, polyvinylchlorides (both plasticized and unplasticized), fluorocarbon resins, such as polytetrafluoroethylene, polystyrenes, polypropylenes, cellulosic resins, such as cellulose acetate butyrates, acrylic resins, such as polyacrylates and polymethylmethacrylates, thermoplastic blends or grafts such as acrylonitrile-butadiene-styrenes or acrylonitrile-styrenes, polycarbonates, polyvinylacetates, ethylene vinyl acetates, polyvinyl alcohols, polyoxymethylene, polyformaldehyde, polyacetals, polyesters, such as polyethylene terephthalate, polyether ether ketone, and phenol-formaldehyde resins, such as resols and novolacs. Those of skill in the art will recognize that other thermoplastic polymers can be used in the invention in an analogous manner.

Suitable thermoset polymers for use as, or inclusion in, the binder used in the invention include, but are not limited to, polyurethanes, silicones, fluorosilicones, phenolic resins, melamine resins, melamine formaldehyde, and urea formaldehyde. Suitable elasomers for use as or inclusion in, the binder used in the invention include but are not limited to natural and/or synthetic rubbers, like styrene-butadiene rubbers, neoprenes, nitrile rubber, butyl rubber, silicones, polyurethanes, alkylated chlorosulfonated polyethylene, polyolefins, chlorosulfonated polyethylenes, perfluoroelastomers, polychloroprene (neoprene), ethylene-propylene-diene terpolymers, chlorinated polyethylene, VITON (fluoroelastomer), and ZALAK® (Dupont-Dow elastomer).

Those of skill in the art will realize that some of the thermoplastics listed above can also be thermosets, depending upon the degree of crosslinking, and that some of each may be elastomers, depending upon their mechanical properties, and that the particular categorization used above is for ease of understanding and should not be regarded as limiting or controlling. Naturally occurring and synthetically modified naturally occurring polymers suitable for use in the invention include, but are not limited to, natural and synthetically modified celluloses, such as cotton, collagens, and organic acids. Biodegradable polymers suitable for use in the invention include, but are not limited to, polyethylene glycols, polylactic acids, polyvinylalcohols, co-polylactideglycolides, and the like.

In the specific embodiment of a filter material that may be sterilized the mineral filtration material originating from natural or synthetic sources and GAC or bone char material are present in approximately equal amounts, with the percentage of binders kept to a minimum. The binders used must be stable to the temperature, pressure, electrochemical, radiative, and chemical conditions presented in the sterilization process, and should be otherwise compatible with the sterilization method. Examples of first binders can include acrylamides, acrylates, and any stable polyelectrolytes. Examples of second binders suitable for sterilization methods involving exposure to high temperatures (such as steam sterilization or autoclaving) include cellulose nitrate, polyethersulfone, nylon, polypropylene, polytetrafluoroethylene (teflon), and mixed cellulose esters. Purification materials prepared with these binders can be autoclaved when the binder polymers are prepared according to known standards. Desirably, the purification material is stable to both steam sterilization or autoclaving and chemical sterilization or contact with oxidative or reductive chemical species, as this combination of sterilizing steps is particularly suitable for efficient and effective regeneration of the purification material. Additionally, sterilization and regenerating of devices incorporating the mineral materials may be conducted by passing solutions of apatite, alum, acid, and/or caustic through the filter.

In the embodiment of the invention wherein sterilization is at least in part conducted through the electrochemical generation of oxidative or reductive chemical species, the electrical potential necessary to generate said species can be attained by using the purification material itself as one of the electrodes. For example, the purification material, which contains polymeric binder, can be rendered conductive through the inclusion of a sufficiently high level of conductive particles, such as GAC, carbon black, or metallic particles to render a normally insulative polymeric material conductive. Alternatively, if the desired level of carbon or other particles is not sufficiently high to render an otherwise insulative polymer conductive, an intrinsically conductive polymer may be used as or blended into the binder. Examples of suitable intrinsically conductive polymers include doped polyanilines, polythiophenes, and other known intrinsically conductive polymers. These materials can be incorporated into the binder in sufficient amount to provide a resistance of less than about 1 kΩ, more particularly less than about 300 Ω.

The purification material of the present invention need not be in the form of a block, but may also be formed into a self-supporting sheet or film. This sheet or film may, in a particular embodiment, be disposed on a woven or nonwoven web of, e.g., a polymer. The polymer used to form the woven or nonwoven web may be any thermoplastic or thermosetting resin typically used to form fabrics. Polyolefins, such as polypropylene and polyethylene, are particularly suitable in this regard.

The purification material of the present invention need not be in the form of a block, or sheet but may also be formed into a coating which may be disposed on a porous or nonporous supporting substrate. This coating may, in a particular embodiment, be disposed on a woven or nonwoven web of, e.g., a polymer. The polymer used to form the woven or nonwoven web may be any thermoplastic or thermosetting resin typically used to form fabrics. Polyolefins, such as polypropylene and polyethylene, are particularly suitable in this regard. The coating may be disposed on a metal surface such as a sheet, fiber, or wire. Suitable metals include steel, iron containing alloys, precious metals, silver, copper, and gold, and aluminum, and coinage metals. The coating may be disposed on a metal surface such as a mesh or screen. Suitable meshes include those made from steel, iron containing alloys, precious metals, silver, copper, and gold, and aluminum, and coinage metals.

The efficiency of the purification material and the method for using it to reduce chemical and microbiological contaminants and the flow rate of the fluid through the material, are a function of the pore size within the block and the influent fluid pressure. At constant fluid pressure, flow rate is a function of pore size, and the pore size within the block can be regulated by controlling the size of the mineral particulate and GAC granules. For example, a large granule size provides a less dense, more open purification material which results in a faster flow rate, and small granule size provides a more dense, less open purification material which results in a slower flow rate. A block 17 formed with relatively large filtration particle granules will have less surface area and interaction sites than a block formed with smaller granules. Accordingly, the purification material of large granules must be of thicker dimension to achieve equal removal of microbiological contaminants. Because these factors are controllable within the manufacturing process, the purification materials can be customized by altering pore size, block volume, block outer surface area, and geometric shape to meet different application criteria. Average pore size in a particular embodiment is kept to below several microns, and more particularly to below about one micron, to preclude passage of cysts. It should be noted that the pore size described herein does not refer to the pores within the enlarged particles or in the particles comprising the enlarged particles or other adsorbent particles themselves, but rather to the pores formed within the purification material when the particles are aggregated together by the binder.

The method of making the material of the invention, in its most general aspect, involves combining the particulate filtration material (and optional additional particulate adsorbent material(s) with the first binder material under conditions of pressure and temperature that allow interaction between the materials and flocculation, coagulation, agglomeration, or a combination thereof, and a second binder material under conditions of pressure and temperature that allow at least a portion of the binder to be present in liquid form and that allow for compaction of the particulate, and then solidifying the binder around and/or between the particles. The precise nature of the production process will depend to a certain extent upon the nature of the binder materials.

For example, if the first binder material is supplied in the form of a liquid solution, suspension, or emulsion (e.g., in a volatile solvent), it may be contacted with the particles by dipping or spraying, and the wet particles compressed in a mold. The mold may be optionally heated to evaporate any necessary solvent or binder. The resulting molded material is then dried to form a purification material which can then be milled to the desired particle size desired for interaction with the second binder. The wet material may also be extruded or dewatered and then processed to the desired particle size.

In similar fashion, if the first or second binder material is supplied in the form of a liquid solution, suspension, or emulsion (e.g., in a volatile solvent), it may be contacted with the particles generated in the first binding process by dipping or spraying, and the wet particles compressed in a mold. The mold may be optionally heated to evaporate any necessary solvent. The resulting molded material is then dried to form the purification material of the invention.

If, on the other hand, the first or second binders are a polymer resin, it will typically be mixed in pellet form with the particles of the adsorbent material, and the resulting mixture heated and extruded or molded into the desired shape. Examples of suitable particulate/binder extrusion processes and equipment are disclosed in U.S. Pat. Nos. 5,189,092; 5,249,948; and 5,331,037. Other extrusion equipment and processes may also be used. Moreover, the mixture may be heated and injection molded, without the need for any extrusion. Additionally, the binder, a thermoset, may be generated through a crosslinking process that incorporates initiation by chemical processes, electrochemical processes, irradiation and through physical parameters of temperature and pressure variations.

With reference to the drawings, the invention and a mode of practicing it will now be described with regard to one particular embodiment, which significantly exceeds the EPA requirements for microbiological filters.

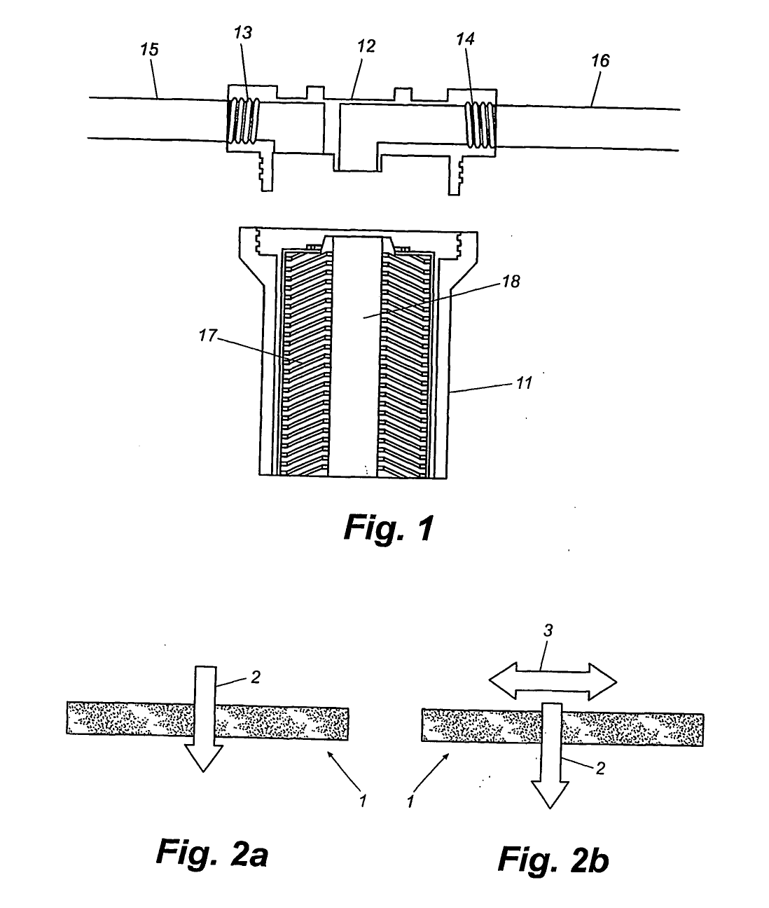

FIG. 1 illustrates a typical specific embodiment of a filtration apparatus containing the purification material of the invention, which incorporates a rigid porous block filter. A removable housing 11 is mated with a cap 12, the cap 12 having an inflow orifice 13 and an outflow orifice 14. A water supply conduit 15 is joined to the inflow orifice 13 to deliver non-treated water into the device, and a water discharge conduit 16 is joined to the outflow orifice 14 to conduct treated water from the device. Water passes into the housing 11. The pressure of the water flow forces it through the porous block filter member 17, which as shown is formed in the shape of hollow cylinder with an axial bore 18. The treated water then passes into the axial bore 18 which connects to the outflow orifice 14. FIG. 2 is provided as a representative illustration of one possible configuration. It is to be understood that other configurations where water is caused to pass through a porous filter block (which may have different geometrical shapes and/or different flow properties) are contemplated to be within the scope of the invention. The block 17 may be formed by any of a number of known methods, such as by extrusion, compression, molding, sintering or other techniques.

FIGS. 2a and 2b shows two embodiments where the purification material of the invention is used in the form of a sheet or film. FIG. 2a shows purification material 1 used in connection with normal flow-through filtration, indicated by arrow 2, which represents the fluid being filtered by passage through the sheet or film 1. FIG. 2b shows purification material 1 used in connection with crossflow filtration. Fluid flowing across the filter is indicated by double-headed arrow 3, while fluid flowing through the purification material 1 is indicated by arrow 2. The cross flow fluid indicated by arrow 3 sweeps across the surface of the purification material 1, decreasing the level of particulate matter deposited thereon.

### EXAMPLE 1

A cylindrical filter block 17 of the shape shown in FIG. 2 may be prepared with a material composition of approximately 42.5% apatite obtained from Murlin Chemical in PA in the form of hydroxycalciumphosphate and approximately 42.5% GAC obtained from KX Industries. Approximately 10% inorganic binder, selected from one or more of the inorganics described above, as a first binder is used to increase the particle size of the hydroxycalciumphosphate and 15% (polyethylene) thermoplastic binder material selected from one or more of the thermoplastics described above is used as a second binder to generate the porous block of all components.

The material may be extruded at a temperature that provides a uniform mixture of mineral adsorbent, GAC, aggregating binder and thermoplastic binder. The cylindrical or toroidally shaped block 17 is approximately 9.8 inches in length, with an outer diameter of approximately 2.5 inches and an inner diameter (the bore 18) of approximately 1.25 inches. This shape filter fits into a standard water filtration housing used in the home and industrial settings. The filter material has a resistance of about 300 Ω.

### EXAMPLE 2

The filter prepared in Example 1 may be challenged by exposing it to tap water that is filtered with activated carbon and then seeded with 2.3×10⁸ colony forming units per liter of K. terrigena bacteria and 1.0×10⁷ units per liter of MS2 virus. The seeded water is passed through the filter block 17 at a flow rate of approximately 2 liters/minute for 3 minutes, followed by collection of a 500 ml effluent sample. Bacteria may be assayed on m-Endo agar plates by membrane filtration procedure, while the MS2 virus may be assayed by standard methods.

### EXAMPLE 3

The composite prepared in Example 1 may be used to reduce a water soluble chlorine species such as hypochlorous acid in an oxidized state to a chlorine species in a reduced state (choride). Chlorine levels of approximately 2.0 mg/L were reduced to below the detection limits of standard test strip based assays.

As described above, the material of the invention is extremely useful in the area of water purification, particularly the area of drinking water purification. Because of the extremely high efficiency with which the material of the present invention removes chemicals and microorganisms from water, it meets and exceeds the EPA guidelines for materials used as microbiological and chemical water purifiers. In addition to functioning as a purifier for drinking water, the material of the invention can also be used to purify water used for recreational purposes, such as water used in swimming pools, hot tubs, and spas.

As the result of the ability of the material of the invention to efficiently remove and immobilize microorganisms and other cells from aqueous solutions, it has numerous applications in the pharmaceutical and medical fields. For example, the material of the invention can be used to fractionate blood by separating blood components, e.g., plasma, from blood cells, and to remove microorganisms from other physiological fluids.

The material can also be used in hospital or industrial areas requiring highly purified air having extremely low content of microorganisms, e.g., in intensive care wards, operating theaters, and clean rooms used for the therapy of immunosuppressed patients, or in industrial clean rooms used for manufacturing electronic and semiconductor equipment.

The material of the invention has multiple uses in fermentation applications and cell culture, where it can be used to remove microorganisms from aqueous fluids, such as fermentation broths or process fluids, allowing these fluids to be used more efficiently and recycled, e.g., without cross-contamination of microbial strains. In addition, because the material is so efficient at removing microorganisms and at retaining them once removed, it can be used as an immobilization medium for enzymatic and other processing requiring the use of microorganisms. A seeding solution containing the desired microorganisms is first forced through the material of the invention, and then substrate solutions, e.g., containing proteins or other materials serving as enzymatic substrates, are passed through the seeded material. As these substrate solutions pass through the material, the substrates dissolved or suspended therein come into contact with the immobilized microorganisms, and more importantly, with the enzymes produced by those microorganisms, which can then catalyze reaction of the substrate molecules. The reaction products may then be eluted from the material by washing with another aqueous solution.

The material of the invention has numerous other industrial uses, e.g., filtering water used in cooling systems. Cooling water often passes through towers, ponds, or other process equipment where microorganisms can come into contact with the fluid, obtain nutrients and propagate. Microbial growth in the water is often sufficiently robust that the process equipment becomes clogged or damaged and requires extensive chemical treatment. By removing microorganisms before they are able to propagate substantially, the present invention helps to reduce the health hazard associated with the cooling fluids and the cost and dangers associated with chemical treatment programs.

Similarly, breathable air is often recycled in transportation systems, either to reduce costs (as with commercial airliners) or because a limited supply is available (as with submarines and spacecraft). Efficient removal of microorganisms permits this air to be recycled more safely. In addition, the material of the invention can be used to increase indoor air quality in homes or offices in conjunction with the air circulation and conditioning systems already in use therein.

The purification material of the invention can also be used to purify other types of gases, such as anesthetic gases used in surgery or dentistry (e.g., nitrous oxide), gases used in the carbonated beverage industry (e.g., carbon dioxide), gases used to purge process equipment (e.g., nitrogen, carbon dioxide, argon), and/or to remove particles from surfaces, etc.

In each of these applications, the method of using the material of the invention is relatively simple and should be apparent to those of skill in the filtration art. The fluid or gas to be filtered is simply conducted to one side of a block or sheet of material of the invention, typically disposed in some form of housing, and forced through the material as the result of a pressure drop across the purification material. Purified, filtered fluid or gas is then conducted away from the “clean” side of the filter and further processed or used.

The invention having been thus described by reference to certain of its specific embodiments, it will be apparent to those of skill in the art that many variations and modifications of these embodiments may be made within the spirit of the invention, which are intended to come within the scope of the appended claims and equivalents thereto.

1. A purification material for fluids, wherein the material comprises insoluble filtration particles aggregated with a first binder and combined into the form of a porous block, porous sheet, porous coating or a non-porous coating using a second binder.

2. The purification material of claim 1, wherein the material is in the form of a porous block.

3. The purification material of claim 2, wherein the porous block is rigid.

4. The purification material of claim 2, wherein the porous block is flexible.

5. The purification material of claim 1, wherein the material is in the form of a porous sheet.

6. The purification material of claim 5, wherein the porous sheet is rigid.

7. The purification material of claim 5, wherein the porous sheet is flexible.

8. The purification material of claim 1, wherein the material is in the form of a porous coating.

9. The purification material of claim 8, wherein the porous coating is contained on a substrate which is rigid.

10. The purification material of claim 8, wherein the porous coating is contained on a substrate which is flexible.

11. The purification material of claim 1, wherein the material is in the form of a non-porous coating.

12. The purification material of claim 11, wherein the non-porous coating is contained on a substrate which is rigid.

13. The purification material of claim 11, wherein the non-porous coating is contained on a substrate which is flexible.

14. The purification material of claim 1, wherein at least a portion of said insoluble filter material is carbon in a form selected from particles, fibers, or a combination thereof.

15. The purification material of claim 1, wherein at least a portion of said insoluble filtration material is derived from minerals containing apatites, phosphates, silicates, hydroxides, oxides or combinations thereof.

16. The purification material of claim 1, wherein the first binder is a polymer material.

17. The purification material of claim 16, wherein the first binder is a polymer material containing positive charges, negative charges, hydrogen bonding sites, or a combination thereof.

18. The purification material of claim 17, wherein the first binder is a polyelectrolyte material derived from natural polymers or modified natural polymers.

19. The purification material of claim 18, wherein the first binder is a polyelectrolyte material known as cationic starch.

20. The purification material of claim 17, wherein the first binder is a polyelectrolyte material selected from the group consisting of polyamines, polyamides, polyalcohols, polysaacharides, polyacrylamides, polyacrylates, humic acids, proteins, poly(DADMAC), Poly-DADM, polyamine-poly(DADMAC) blends, polyquartenary amines, inorganic-polyamine blends, and inorganic Poly(DADMAC) blends, cationic starch, cationic polymethylmethacrylates, copolymers of vinylimidazolium methochloride and vinylpyrrolidone, quarternized vinylpyrrolidone/dimethyl-aminoethyl-methacrylate copolymer, and polyethyleneimine.

21. The purification material of claim 1, wherein the first binder is selected from the group consisting of metal hydroxides and oxides.

22. The purification material of claim 21, wherein the first binder is selected from the group containing aluminum, calcium, magnesium, iron, polyaluminum sulfates, polyaluminum chlorides, polyorganozirconates, polyorganoaluminates, polysiloxanes, polysilanes, polysilazanes, polycarbosilanes, polyborosilanes, zirconium dimethacrulate, zirconium tetramethacrylate, zirconium 2-ethylhexanoate, aluminum butoxides, aluminum diisopropoxide ethylacetoacetate, tetramethyldisiloxanes and derivatives thereof, tristrimethylsilylphosphate, and tristrimethylsiloxyboron.

23. The purification material of claim 21, wherein the first binder is a metal oxide or hydroxide derived from aluminum, calcium, magnesium, or iron.

24. The purification material of claim 1, wherein the second binder is a polymer material.

25. The purification material of claim 24, wherein the binder is a polymer melting between about 50° C. and about 500° C.

26. The purification material of claim 24, wherein the polymer is stable under sterilization conditions.

27. The purification material of claim 24, wherein said binder is selected from the group consisting of thermoplastics, polyethylene glycols or a derivative thereof, polyvinyl alcohols, polyvinylacetate, and polylactic acids.

28. The purification material of claim 24, wherein the polymer material is a thermoplastic is selected from the group consisting of nylon, polyethylene, polyvinylchloride, fluorocarbon resins, polystyrene, polypropylene, cellulosic resins, and acrylic resins.

29. The purification material of claim 24, wherein the polymer material comprises a naturally occurring polymer.

30. The purification material of claim 29, wherein the naturally occurring polymer is selected from the group consisting of natural and synthetically modified celluloses, collagens, and organic acids.

31. The composite purification material of claim 29, wherein the naturally occurring polymer is selected from the group consisting of natural and synthetically modified celluloses, collagens, and organic acids.

32. The composite purification material of claim 29, wherein the naturally occurring polymer is a biodegradable polymer selected from the group consisting of a polyethyleneglycol, a polylactic acid, a polyvinylalcohol, a co-polylactideglycolide, cellulose, alginic acids, carrageenans isolated from seaweeds, polysaccharides, pectins, xanthans, starch, and combinations thereof.

33. The purification material of claim 24, wherein the polymer material comprises an electrically conductive polymer.

34. The purification material of claim 24, wherein the polymer material comprises a biodegradable polymer.

35. The purification material of claim 34, wherein the biodegradable polymer is a polyethyleneglycol, a polylactic acid, a polyvinylalcohol, or a co-polylactideglycolide.

36. The purification material of claim 24, wherein said binder is selected from the group consisting of gelling or absorbent materials.

37. The purification material of claim 36, wherein said binder is selected from the group consisting of superabsorbents.

38. The composite purification material of claim 37, wherein said superabsorbent comprises a material selected from polyacrylic acids, polyacrylamides, poly-alcohols, polyamines, polyethylene oxides, cellulose, chitins, gelatins. starch, polyvinyl alcohols and polyacrylic acid, polyacrylonitrile, carboxymethyl cellulose, alginic acids, carrageenans isolated from seaweeds, polysaccharides, pectins, xanthans, poly-(diallyldimethylammonium chloride), poly-vinylpyridine, poly-vinylbenzyltrimethylammonium salts, polyvinylacetates, polylactic acids or a combination thereof.

39. The composite purification material of claim 37, wherein the superabsorbent material comprises an ionically charged surface.

40. The composite purification material of claim 37, wherein the superabsorbent material comprises a biodegradable polymer.

41. The purification material of claim 37, wherein said binder is selected from the group consisting polylactic acids, polyacrylamides or combinations of the polymers thereof.

42. The composite purification material of claim 37, wherein the absorbent material comprises a clay or aluminosilicate material.

43. The composite purification material of claim 42, wherein the absorbent material comprises is bentonite.

44. The composite purification material of claim 24, wherein the superabsorbent comprises a material selected from the group consisting of resins obtained by polymerizing acrylic acid and resins obtained by polymerizing acrylamide.

45. The composite purification material of claim 24, wherein the polymer material comprises a naturally occurring polymer, cellulose, alginic acids, carrageenans isolated from seaweeds, polysaccharides, pectins, xanthans, starch, or combinations thereof.

46. The composite purification material of claim 24, wherein the superabsorbent material comprises an ionically charged surface ranging from 1-100% of the material surface.

47. The purification material of claim 6, wherein the purification material is in the form of a sheet and is disposed on a woven web.

48. The purification material of claim 6, wherein the purification material is in the form of a sheet and is disposed on a nonwoven web.

49. The purification material of claim 7, wherein the purification material is in the form of a sheet and is disposed on a woven web.

50. The purification material of claim 7, wherein the purification material is in the form of a sheet and is disposed on a nonwoven web.

51. The purification material of claim 8, wherein the purification material is in the form of a coated substrate and the substrate is rigid.

52. The purification material of claim 51, wherein the substrate is a metal.

53. The purification material of claim 52, wherein the substrate is a coinage metal.

54. The purification material of claim 52, wherein the substrate contains iron.

55. The purification material of claim 51, wherein the substrate is a polymer.

56. The purification material of claim 24, wherein the polymer is derived from synthetic sources.

57. The purification material of claim 56, wherein the synthetic source produces a woven substrate.

58. The purification material of claim 24, wherein the synthetic source produces a non-woven substrate.

59. The purification material of claim 24, wherein the polymer is derived from natural sources.

60. The purification material of claim 59, wherein the natural source produces a woven substrate.

61. The purification material of claim 59, wherein the natural source produces a non-woven substrate.

62. The purification material of claim 8, wherein the purification material is in the form of a coated substrate and the substrate is flexible.

63. The purification material of claim 62, wherein the polymer is derived from synthetic sources.

64. The purification material of claim 63, wherein the synthetic source produces a woven substrate.

65. The purification material of claim 63, wherein the synthetic source produces a non-woven substrate.

66. The purification material of claim 62, wherein the polymer is derived from natural sources.

67. The purification material of claim 66, wherein the natural source produces a woven substrate.

68. The purification material of claim 66, wherein the natural source produces a non-woven substrate.

69. The purification material of claim 51, wherein the substrate conducts electricity.

70. The purification material of claim 62, wherein the substrate conducts electricity.

71. The purification material of claim 1, wherein the binders are present in an amount ranging from about 1 wt % and about 99.9 wt % of the total weight of the purification material.

72. The purification material of claim 1, further comprising one or more additional non-carbon adsorptive materials.

73. The purification material of claim 72, wherein said additional adsorptive material comprises a calcium or magnesium containing phosphate or a calcium or magnesium containing silicate.

74. The purification material of claim 72, wherein said adsorptive material comprises apatite obtained from bone char.

75. The purification material of claim 72, wherein said adsorptive material comprises an aluminum containing silicate, oxide, or hydroxide.

76. The purification material of claim 72, wherein said adsorptive material comprises a magnesium containing hydroxide, oxide, or silicate.

77. The purification material of claim 72, wherein said additional adsorbent material and said insoluble filtration particles are present in approximately equal amounts, further wherein the insoluble filtration particles comprise granulated activated carbon.

78. The purification material of claim 77, wherein said additional adsorbent material and said granulated activated charcoal are each present in amounts of about 42.5 wt %, and said binders are present in an amount of about 15 wt %, based upon the total weight of said purification material.

79. The purification material of claim 72, wherein said additional adsorptive material comprises an ion-binding material selected from the group consisting of synthetic ion exchange resins, zeolites, and phosphate minerals.

80. The purification material of claim 79, wherein the phosphate minerals are members of the phosphate class of minerals.

81. The purification material of claim 79, wherein the phosphate minerals are members of the aluminosilicate group of minerals.

82. The purification material of claim 79, wherein the synthetic ion exchange resins are functionalized styrenes, vinylchlorides, divinyl benzenes, methacrylates, acrylates, and mixtures, copolymers, and blends thereof.

83. The purification material of claim 79 wherein the natural or synthetic zeolites are silicate containing minerals known as clinoptilolite.

84. The purification material of claim 1, further comprising one or more materials that undergo an chemical oxidation or a chemical reduction in the presence of water or aqueous fluid.

85. A device for filtering microbiological contaminants from water or aqueous fluid, comprising:
a housing; and
a porous block of the purification material of claim 1.

86. The device according to claim 85, wherein the housing comprises an inlet, an outlet, and a contacting chamber therebetween, and wherein said porous block is disposed within the contacting chamber, such that fluid can flow into the housing from the inlet passes through the porous block and then can flow out of the housing through the outlet.

87. A method for filtering a fluid to remove any microorganisms therefrom, comprising causing the fluid to flow through the purification material of claim 1, thereby obtaining filtered fluid.

88. The method of claim 87, wherein said fluid is water.

89. The method of claim 89, wherein the filtered water is potable.

90. The method of claim 87, wherein said fluid is an aqueous solution.

91. The method of claim 90, wherein said aqueous solution is blood.

92. The method of claim 90, wherein said aqueous solution is a fermentation broth.

93. The method of claim 90, wherein said aqueous solution is a recycled stream in a chemical or biological process.

94. The method of claim 90, wherein the aqueous solution is a recycled stream in a cell culturing process.

95. The method of claim 90, wherein the aqueous solution has been used in a surgical procedure.

96. The method of claim 87, wherein the fluid comprises breathable air.

97. The method of claim 87, wherein the fluid comprises a purge gas.

98. The method of claim 97, wherein the purge gas is selected from the group consisting of O₂, CO₂, N₂, or Ar.

99. The method of claim 87, wherein the fluid is an anesthetic gas.

100. The method of claim 99, wherein the anesthetic gas comprises nitrous oxide.

101. The method of claim 87, further comprising regenerating said purification material by sterilization.

102. The method of claim 101, wherein said sterilization comprises exposing the purification material to elevated temperature, pressure, radiation levels, or chemical oxidants or reductants, or a combination thereof.

103. The method of claim 101, wherein said sterilization comprises autoclaving.

104. The method of claim 101, wherein said sterilization comprises electrochemical treatment.

105. The method of claim 101, wherein said sterilization comprises a combination of chemical oxidation and autoclaving.

106. The method of claim 87, wherein said fluid is a gaseous mixture.

107. The method of claim 106, wherein the filtered gas is air.

108. The method of claim 87, wherein said fluid is a chemically unreactive gas.

109. The method of claim 87, wherein said gas is oxygen, carbon dioxide, nitrogen, argon, or nitrogen oxides.

110. The method of claim 87, wherein said gas is used to pressurize a chamber.

111. The method of claim 87, wherein said gas is used to sparge or purge an aqueous solution for the purpose of increasing the concentration of the sparging gas in the solution.

112. The method of claim 87, wherein said gas is used to sparge or purge an aqueous solution for the purpose of decreasing the concentration of the gases initially present in the solution.

113. The method of claim 87, wherein said gas is used to remove particulate material from surfaces.

114. An immobilization and contacting medium for microorganisms, comprising magnesium containing mineral and a binder therefor, the medium in the form of a rigid, porous block or a sheet.

115. The immobilization and contacting medium of claim 114, further comprising one or more microorganisms disposed within the pores thereof.

116. The regeneration of the material of claim 1 through the use of solutions comprising salt, acid, or caustic.

117. A method for filtering a fluid to remove any microorganisms therefrom, comprising causing the fluid to flow over the purification material of claim 11, thereby obtaining filtered fluid.
